(19) United States
(12) Patent Application Publication
(10) Pub. No.: US 2012/0325612 A1
(43) Pub. Date: Dec. 27, 2012

(54) LIMITED SLIP AXLE STRIPER

(76) Inventors: James C. Schroeder, Ramsey, MN (US); August F. Legatt, Maple Lake, MN (US); Kelli K. Wold, Becker, MN (US)

(21) Appl. No.: 13/521,687

(22) PCT Filed: Jan. 12, 2011
(86) PCT No.: PCT/US11/20984

§ 371 Date: Jul. 11, 2012

(51) Int. Cl. F16D 7/02

(52) U.S. Cl. 192/56.6

(57) ABSTRACT

The striper has a solid direct drive axle 12 powered either by chain, belt, gears, hydraulics, etc. 14. Two wheels 16 are attached to a solid axle 12 by means of adjustable friction devices 18 that transfer torque—stacked hardened thrust washers 20 with spring washers 22 to maintain a constant drive torque with ability to have limited slip at a specific load range. The spring washers 22 allow consistent load over long periods of wear. When each tire 24 is properly loaded “equally” the striper 26 will have natural ability to travel in a straight forward motion over bumpy surfaces specifically grass (turf), not common with standard type differentials that power only the least resistant wheel 16. When cornering the inside wheel 16 will slip as necessary based on the turning radius. When the wheels 16 are overloaded, wheels will slip, preventing damage to the drive mechanism (transmission) 28.

### TECHNICAL FIELD

This application claims the benefit of U.S. application Ser. No. 61/294,697, filed Jan. 13, 2010, the contents of which are hereby incorporated by reference.

### BACKGROUND ART

This invention is intended for use with line stripers which can be used to apply stripes and other markings to roads, parking lots, athletic fields and the like.

### DISCLOSURE OF THE INVENTION

The instant invention is intended to deliver straighter lines for the application of field (and other) striping by means of power transfer through a solid axle with each wheel attached to the solid axle by friction slip device. The instant invention greatly increases the performance, handling and turning of a striper at an affordable cost with minimal parts consuming a very small area.

This invention pertains to a solid direct drive axle powered either by chain, belt, gears, hydraulics, etc. Two wheels are attached to a solid axle by means of adjustable friction devices that transfer torque. It is important to note this friction device that transfers torque could have many configurations. The preferred embodiment utilizes stacked hardened thrust washers with spring washers to maintain a constant drive torque with ability to have limited slip at a specific load range. The spring washers allow consistent load over long periods of wear. When each tire is properly loaded “equally” the striper will have natural ability to travel in a straight forward motion over bumpy surfaces specifically grass (turf), not common with standard type differentials that power only the least resistant wheel. When cornering the inside wheel will slip as necessary based on the turning radius. When the wheels are overloaded, wheels will slip, preventing damage to the drive mechanism (transmission). When engaging the drive it will naturally produce a soft start preventing paint from spilling from the bucket. The axle assembly of the instant invention may be used with either a directly powered line striper or with a drive assembly such as Graco Inc.'s LINEDRIVER product which is used with a walk-behind striper.

Advantages to the instant invention include (1) straight lines, very important on turf grass; (2) easy turning and dual wheel drive at the same time; (3) soft start when engaging drive; (4) no ripped up turf from wheel skidding, because of cornering or from abrupt starts; and (5) no bogging down engine in high load conditions which also prevents over-loading transmission.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a cross-section of a striper and axle utilizing the instant invention.

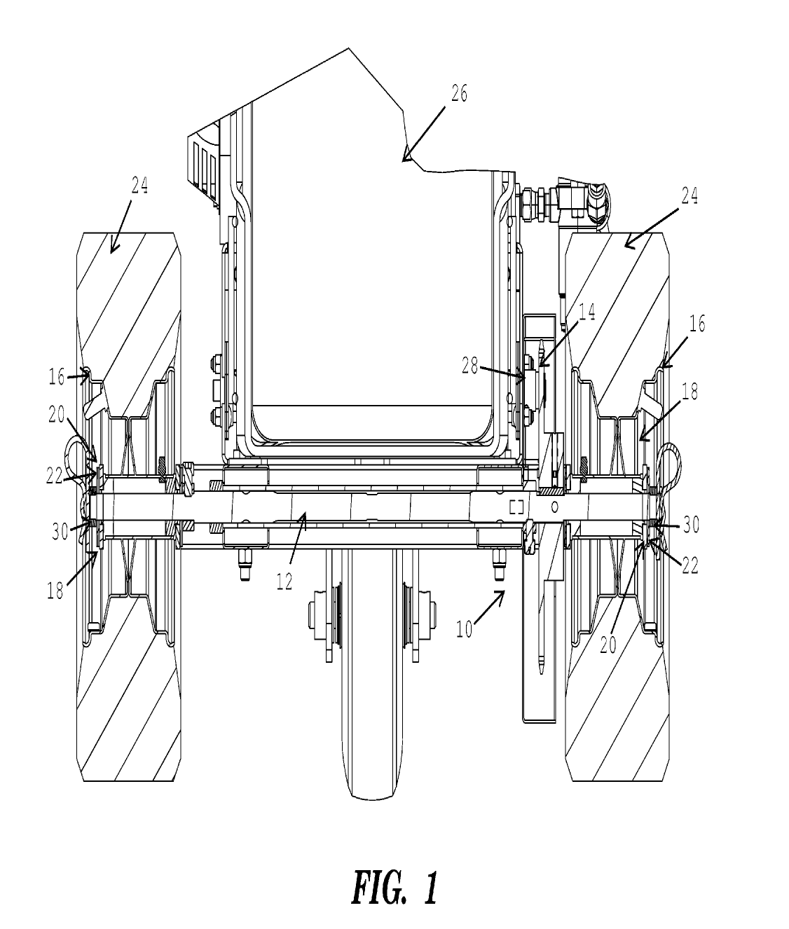

### BEST MODE FOR CARRYING OUT THE INVENTION

This invention 10 pertains to a solid direct drive axle 12 powered either by a drive mechanism 14 (such as a chain, belt, gears, hydraulics, etc.) Two wheels 16 are attached to a solid axle 12 by means of adjustable friction devices 18 that transfer torque. It is important to note this friction device 18 that transfers torque could have many configurations. The preferred embodiment utilizes stacked hardened thrust washers 20 with spring washers 22 to maintain a constant drive torque with ability to have limited slip at a specific load range. The spring washers 22 allow consistent load over long periods of wear. The spring washers 22 are loaded by tightening axle nuts 30. When each tire 24 is properly loaded “equally” the striper 26 will have natural ability to travel in a straight forward motion over bumpy surfaces specifically grass (turf), not common with standard type differentials that power only the least resistant wheel 16. When cornering the inside wheel 16 will slip as necessary based on the turning radius. When the wheels 16 are overloaded, wheels will slip, preventing damage to the drive mechanism (transmission) 28.

It is contemplated that various changes and modifications may be made to the drive assembly without departing from the spirit and scope of the invention as defined by the following claims.

1. A limited slip drive assembly for use on a line striper, said drive assembly comprising:
a drive axle powered by a drive mechanism; and
two wheels attached to said axle, said wheels being attached by adjustable friction devices that transfer torque.

2. The limited slip drive assembly of claim 1 wherein each said adjustable friction device comprises a hardened thrust washer and a spring washers to maintain a constant drive torque with ability to have limited slip at a specific load range.
